(19) United States
(12) Patent Application Publication
(10) Pub. No.: US 2006/0031047 A1
(43) Pub. Date: Feb. 9, 2006

(54) Garment-model computer simulations

(75) Inventors: Geoff Bingham, Warwickshire (GB); Martin Bentham, (US); David Bruner, Cary, NC (US)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: Sara Lee Corporation

(21) Appl. No.: 11/152,900

(22) Filed: Jun. 15, 2005

Related U.S. Application Data
(60) Provisional application No. 60/579,860, filed on Jun. 15, 2004.

(51) Int. Cl. G06G 7/48

(52) U.S. Cl. 703/6; 700/90

(57) ABSTRACT

A garment-model computer simulation is provided that has a model portion and a garment portion. The model portion has a first layer and a second layer. The garment portion has a third layer. The first and third layers are organized with the second layer. The garment portion has an adjustable periphery that, when adjusted, distorts a node spacing within each of the first, second, and third layers.

### BACKGROUND OF THE INVENTION

1. Field of the Invention

The present invention relates to computer simulations. More particularly, the present invention relates to garment-model simulations for use in the design of garments.

2. Description of Related Art

The design and analysis of garments involves the consideration of a number of different criteria. One criteria is the fit and/or comfort of the garment on the wearer. Another criteria is the degree of support and/or shaping (e.g., deformation) the garment provides, if any, to the wearer. The degree of shaping provided by the garment can be a measure of the resultant aesthetic look of the garment, when worn.

Human fit models are typically used to test these criteria during the garment design process. Fit models are persons having a predetermined body size and/or shape that approximates the target wearer of the garment. Typically, the fit model and designer evaluate the above mentioned design and analysis criteria using a trial-and-error process. Here, the designer prepares a sample garment, which is then worn by the fit model. The fit model and designer then subjectively determine whether the sample garment is acceptable as compared to the criteria. Any deficiencies in this subjective determination are noted and another sample garment is prepared to correct any deficiencies.

The trial-and-error process continues until the subjective analysis by the fit model and designer determine that the sample garment is acceptable, a process which is known to require five or more iterations. Thus, the trial-and-error process is generally inefficient and costly. Further, the trial-and-error process is subjective to the particular fit model(s) and designer and is based on two data points, namely the designer and the fit model.

Mathematical simulation techniques such as, but not limited to boundary element, finite difference, the numerical solution of system differential equations, and finite element analysis (FEA) are known. For example, FEA is a computer-based tool that allows for linear and/or nonlinear structural analysis of stress analysis problems. Unfortunately, FEA has not proven effective in reducing or mitigating the aforementioned deficiencies and deleterious effects of trial-and-error garment design processes.

Accordingly, it has been determined that there is a need for garment-model simulations for use in FEA assisted design of garments.

### BRIEF SUMMARY OF THE INVENTION

It is an object of the present invention to provide garment-model computer simulations for use in FEA assisted design of garments.

It is another object of the present invention to provide garment-model computer simulations that can be used to evaluate both the comfort and shaping criteria.

It is yet another object of the present invention to provide multiple layer garment-model computer simulations.

It is still another object of the present invention to provide garment-model computer simulations having a variable number of layers.

It is a further object of the present invention to provide easily adjustable garment-model computer simulations.

It is yet a further object of the present invention to provide garment-model computer simulations having a model size that is selectable.

These and other objects and advantages of the present invention are provided by a garment-model computer simulation having a model portion and a garment portion. The model portion has a first layer and a second layer. The garment portion has a third layer. The first and third layers are organized with the second layer. The garment portion has an adjustable periphery that, when adjusted, distorts a node spacing within each of the first, second, and third layers.

The present invention also provides a garment-model computer simulation including a first layer organized with a second layer and a third layer organized with the second layer. The simulation includes a first region having a first number of second layers and a second region having a second number of second layers.

The present invention further provides a garment-model computer simulation including a model portion and a garment portion. The model portion has a first layer and at least one second layer. The garment portion has a third layer. The first and third layers are organized with the at least one second layer. The at least one second layer includes one second layer where the garment portion deforms the model portion in a single direction and a plurality of second layers where the garment portion deforms the model portion in a plurality of directions.

The above-described and other features and advantages of the present invention will be appreciated and understood by those skilled in the art from the following detailed description, drawings, and appended claims.

### BRIEF DESCRIPTION OF THE SEVERAL VIEWS OF THE DRAWINGS

FIG. 1 is a side perspective view of an exemplary embodiment of a garment-model simulation according to the present invention;

FIG. 2 is a sectional view of FIG. 1 taken along lines 2-2;

FIG. 3 is a front perspective view of the garment-model simulation of FIG. 1;

FIG. 4 is a sectional view of FIG. 3 taken along line 4-4 before adjustment; and

FIG. 5 is a view of FIG. 4 after adjustment.

### DETAILED DESCRIPTION OF THE INVENTION

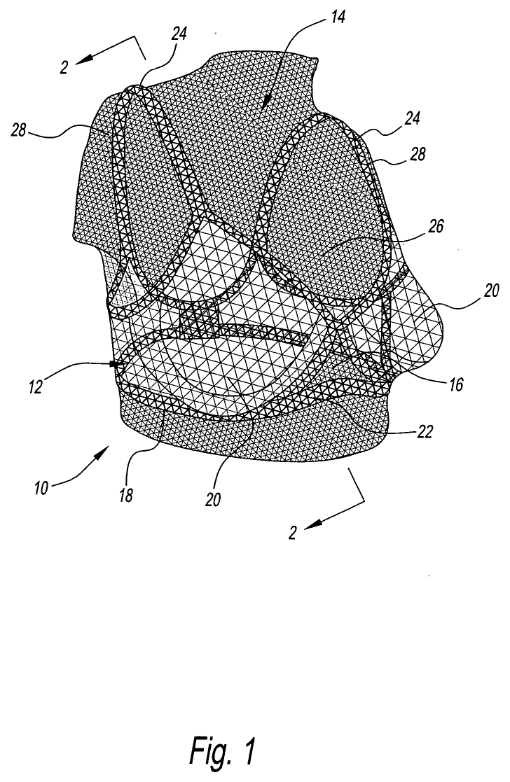

Referring to the drawings and in particular to FIG. 1, an exemplary embodiment of a garment-model simulation according to the present invention is generally represented by reference numeral 10. Simulation 10 is a multiple layer computer simulation that includes a garment 12 appropriately positioned on one or more portions of a model 14. Simulation 10 can be constructed using methods, such as, but not limited to, the method set forth in co-pending U.S. application Ser. No. [Attorney Docket No. 2197.020USU], the contents of which are incorporated herein by reference in their entirety.

Simulation 10 has-been found useful in the design and analysis of garment 12 on model 14. For example, simulation 10 can be used with a finite element analysis (FEA) program to determine the stress (e.g., comfort) and deformation (e.g., shaping) resulting from garment 12 on model 14. Importantly, simulation 10 provides an accurate solution, as well as a rapid solution, for both the stress and deformation.

It has been determined that the accuracy of the solution and the time to achieve the solution are important variables in the usability of simulation 10 for garment design. In typical FEA analysis, high accuracy solutions require increased solution times. Increased solution times increases the cycle time to unacceptable levels for designing the garment using simulation 10. Advantageously, simulation 10 achieves a desired accuracy in a desired solution time.

For purposes of explanation, garment 12 is shown as a brassiere 16 having an outer periphery 18 defining a pair of breast cups 20, an under band 22, and a pair of shoulder straps 24, while model 14 is defined as an upper torso having a pair of breasts 26 and a pair of shoulders 28. Of course, it is contemplated by the present invention for simulation 10 to be representative of other portions of model 14 and/or for garment 12 to be other garments.

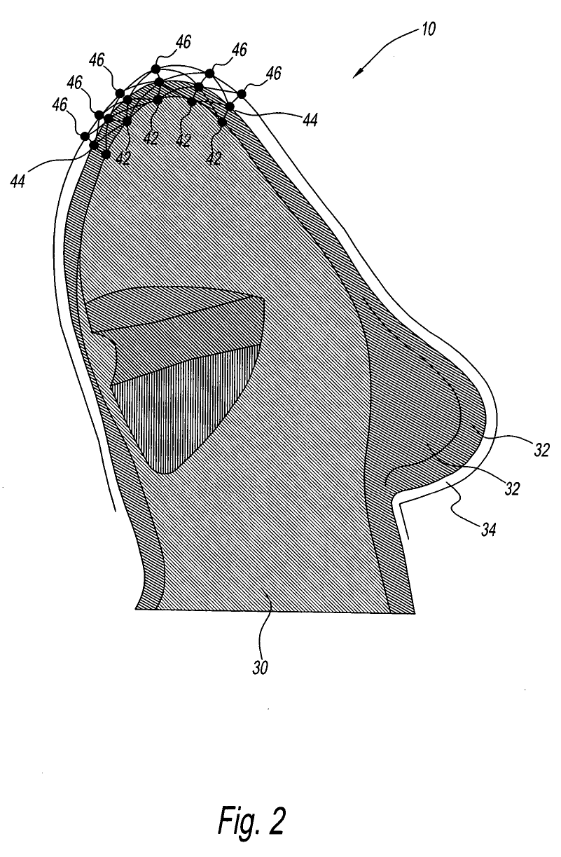

Referring to FIGS. 1 and 2, simulation 10 is a multiple layer simulation having a first layer 30, one or more second layers 32, and one or more third layers 34. The first and second layers 30, 32 represent model 14, while third layer 34 represents garment 12.

Advantageously, model 14 has a size that is selectable by the garment designer. In this manner, simulation 10 can be adjusted by garment designers for the design of various size garments 12. For example, the size of one or more attributes of model 14 can be adjusted by the garment designer. In the example where garment 12 is a brassiere, model 14 can be selected to have a desired size such as, but not limited to, a breast size, shoulder size, waist size, or any combinations thereof.

It has been determined that model 14 can be accurately represented in simulation 10 without defining the entire depth of tissue of the human body. Rather in simulation 10, model 14 is defined by first layer 30, and one or more second layers 32. First layer 30 has a non-adjustable stiffness modulus that renders the first layer stiff to deformation. The one or more second layers 32 have an aggregate stiffness modulus that approximates the stiffness of a human body. In embodiments having more than one second layer 32, each individual layer can have the same or different stiffness modulus. For example, each of the second layers 32 can have a stiffness modulus that approximates a different portion of human tissue such as, but not limited to, skin, fat, muscle, bone, and the like.

It has also been determined that garment 12 can be accurately represented in simulation 10 with one or more third layer 34. Third layer 34 has a stiffness modulus that can be varied by the designer. The designer can vary the stiffness modulus of third layer 34 by choosing various fabric attributes for garment 12. Exemplary fabric attributes selectable by the garment designer that can effect the stiffness modulus of third layer 34 can include attributes such as, but not be limited to, the number of fabric layers, the fabric stitch pattern, the type of yarn or yarns, the presence or absence of stiffening members (e.g., under wires, center-gores, etc), and others.

It has been found that the number of second and/or third layers 32,34 can be varied in various regions of simulation 10 to significantly increase the solution speed for the simulation without decreasing the accuracy of the solution. Specifically, simulation 10 has a variable number of second and/or third layers 32, 34, depending on the region of the simulation being represented.

In second layer 34, it has been found that the individual layers of tissue (e.g., skin, fat, muscle, etc.) exhibit movement from layer-to-layer. For example, stress applied to the skin of a human tends to move the skin relative to the underlying tissue layer. Accurate representation of the layer-to-layer movement in simulation 10 is desired to provide an accurate analysis of the resultant shaping of model 14 due to garment 12. Thus, the number of second layers 32 that would be included in simulation 10 would normally be proportional to the distortion accuracy desired from the simulation. Unfortunately, increasing the number of second layers 32 in simulation 10 results in an unacceptable increase in solution time.

Advantageously, it has been found that the number of second layers 32 can be increased and/or reduced, as needed, in certain regions of simulation 10 to achieve the desired accuracy and solution speed. Thus, simulation 10 has a variable number of second layers 32, depending on the region of the simulation being represented.

In the example shown in FIG. 1, breast cups 20 compress breasts 26 inwardly, lift the breasts upwardly, and urge the breasts toward one another. Thus, the deformation in the region of breast cups 20 occurs in multiple direction (e.g., compression, lift, etc). It has been found that multiple direction deformation can be accurately represented by a number of second layers 32.

Also in the example shown in FIG. 1, shoulder straps 24 compress shoulder regions 28. Similarly, under band 22 compresses against model. Thus, the deformation in these regions occurs in single direction (e.g., compression). It has been found that single direction deformation can be accurately represented by a single second layer 32.

Accordingly, simulation 10 has a variable number of second layers 32 depending on the number of stresses applied in the particular area to achieve the desired accuracy and solution speed. In this manner, simulation 10 maximizes the accuracy, while minimizing the solution time.

In one embodiment, simulation 10 has two second layers 30 in the region of breasts 26, but only one second layer 32 in all other regions of model 14. In another embodiment, simulation 10 has between about five and about ten second layers 30 in the region of breasts 26. Of course, it is contemplated by the present invention for simulation 10 to have any number of second layers 32 in different regions of the simulation such that the desired accuracy and solution speed are achieved. Further, it is contemplated by the present invention for simulation 10 to have any number of third layers 34 in different regions of the simulation such that the desired accuracy and solution speed are achieved.

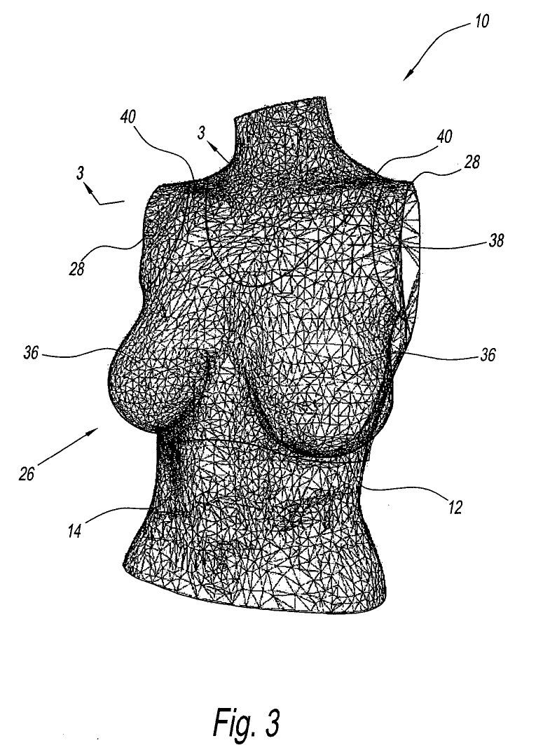

As shown in FIG. 3, simulation 10 can have at least one first region 36 and at least one second region 38. Here, first region 36 is defined in the area of breasts 26, while second region 38 is defined in other parts of the simulation. First region 36 has a first number of second layers 32, while second region 38 has a second number of second layers 32. Of course, it is contemplated by the present invention for simulation 10 be divided into more than just first and second regions 36, 38. For example, it is contemplated for simulation 10 to have a third region 40 defined in the area of shoulders 28. In this embodiment, each region 36, 38, 40 has a different number of second layers 32 from one another to further increase the accuracy of the solution provided by simulation 10 without significantly increasing the solution time.

Each layer 30, 32, 34 is defined by a set of nodes that are meshed together to form the particular layer. For example, first layer 30 is defined by a mesh of first nodes 42, second layer 32 is defined by a mesh of second nodes 44, and third layer 34 is defined by a mesh of third nodes 46. For purposes of clarity, only a portion of the mesh of the first, second and third nodes 42, 44, 46 are shown in FIG. 2.

The first, second, and third layers 30, 32, 34 are organized with one another. As used herein, the term “organized” shall mean that a particular node in one layer is associated with or connected to one or more particular nodes on another layer. As seen in FIG. 2, first nodes 42 in first layer 30 are organized with one or more second nodes 44 of second layer 32, while each second node is also organized with one or more of third nodes 46 of third layer 34.

In some exemplary embodiments, simulation 10 can be adjusted by the user. It has been determined that adjustment of simulation 10 can allow the simulation to be used by garment designers, who are typically unskilled in the generation and use of FEA simulations.

Traditionally, adjusting an FEA simulation requires disconnection of the mesh of nodes for the layer to be modified from the mesh of nodes of the remaining layers. Once disconnected, the layer to be modified can be adjusted. After being adjusted, the mesh of nodes of the modified layer can then reconnected to the mesh of nodes of the remaining layer or layers. Unfortunately, the skills necessary to modify FEA simulations are typically outside the skill of most garment designers. Thus, a minor change to the FEA simulation, such as modifying the width of a brassiere's shoulder strap, has previously required large amounts of training for the garment designer in FEA simulation or the use of a second person skilled in FEA simulation.

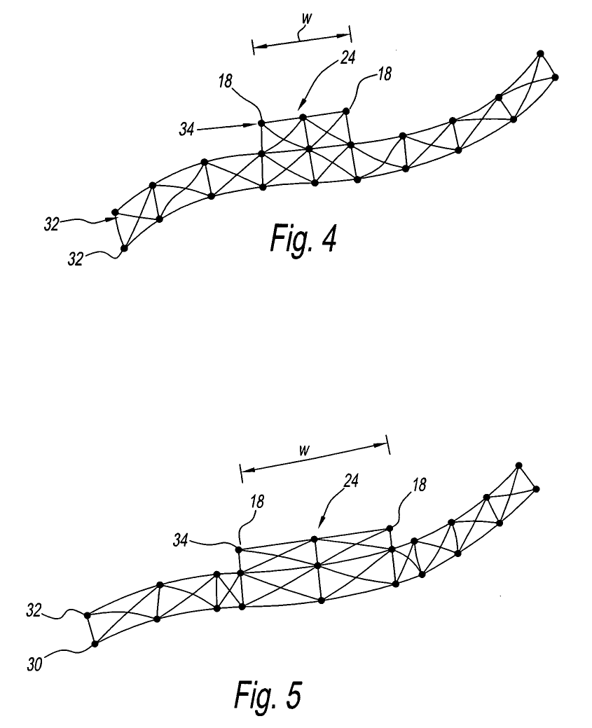

Advantageously, periphery 18 in simulation 10 can easily be adjusted by garment designers. The adjustment of simulation 10 is described with reference to FIGS. 4 and 5, which illustrate only the shoulder strap region of the simulation. Here, simulation 10 is shown before adjustment of periphery 18 in FIG. 4, but after adjustment of the periphery in FIG. 5. In this example, the width “W” of shoulder strap 24 is increased by 100% in FIG. 5 as compared to FIG. 4.

Advantageously, simulation 10 can easily be adjusted by the user through the adjustment of periphery 18. For example, the position, shape, location and other attributes of periphery 18 can be adjusted using a click-and-drag type operation as is known in computer aided drafting (CAD) software applications. The adjustment of periphery 18 distorts the spacing between the individual nodes 42, 44, 46 in the first, second, and third layers 30, 32, 34, respectively. In essence, adjustment to periphery 18 distorts the first, second, and third layers 30, 32, 34 to the desired shape.

The distortion of simulation 10 does not change the overall geometry of the model or garment. Rather, the distortion only effects the organization of the mesh of nodes 42, 44, 46 by increasing and/or decreasing the distance between adjacent nodes in the area local to the periphery adjustment. In the illustrated example, the distance between the nodes in each layer 30, 32, 34 in the area of shoulder strap 24 are increased in FIG. 5 as compared to FIG. 4. Conversely, the distance between the nodes in each layer 30, 32, 34 in the area adjacent to shoulder strap 24 are decreased in FIG. 5 as compared to FIG. 4.

In the illustrated example, only the distance between the nodes immediately adjacent to the shoulder strap region have been reduced in size. Of course, it is contemplated by the present invention for the distortion of node distance to be spread out among more than the immediately adjacent nodes.

Advantageously, it has been found that the distortion of simulation 10 does not significantly effect the accuracy of the solution of the simulation. Thus, simulation 10 can easily be modified by the garment designer, without the need for specialized FEA simulation training and without significantly effect the accuracy of the solution provided by the simulation.

In one exemplary embodiment, simulation 10 is a zero gravity simulation. Here, simulation 10 can be been pre-solved to remove gravitational forces from model 14. It has been found that zero gravity simulation 10 also minimizes the solution time without negatively affecting accuracy. For example, it has been found that pre-solving model 14 to zero gravity reduces the solution time by removing the calculation time that would otherwise be required to move from a state of full gravity on the model to a supported state due to the effects of garment 12 on the model.

As set forth above, simulation 10 is a multiple and variable layer stiffness simulation of garment 12 and model 14. It has been found that simulation 10 accurately reflects the resultant deformation without affecting the speed of the solution. For example, simulation 10 is, in some embodiments, solvable using linear FEA calculations, which provides for more rapid solution time than would be possible using more time consuming non-linear calculations. In other embodiments, simulation 10 can be a zero-gravity simulation so that the solution time can be minimized. Further, simulation 10 can be easily modified by garment designers, without the need for specialized training or the assistance of FEA specialists.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present invention has been described with reference to one or more exemplary embodiments, it will be understood by those skilled in the art that various changes may be made and equivalents may be substituted for elements thereof without departing from the scope of the present invention. In addition, many modifications may be made to adapt a particular situation or material to the teachings of the invention without departing from the scope thereof. Therefore, it is intended that the present invention not be limited to the particular embodiment(s) disclosed as the best mode contemplated, but that the invention will include all embodiments falling within the scope of the appended claims.

What is claimed is:

1. A garment-model computer simulation comprising:
a model portion having a first layer and a second layer, said second layer being organized with said first layer; and
a garment portion having a third layer, said third layer being organized with said second layer, said garment portion having an adjustable periphery that, when adjusted, distorts a node spacing within each of said first, second, and third layers.

2. The simulation as in claim 1, wherein said first layer has a non-adjustable stiffness modulus that renders the first layer stiff to deformation.

3. The simulation as in claim 1, wherein said second layer has an aggregate stiffness modulus that approximates a stiffness of a human body.

4. The simulation as in claim 1, wherein said second layer comprises a single second layer in a first region and a plurality of second layers in a second region.

5. The simulation as in claim 4, wherein said plurality of second layers comprises two second layers.

6. The simulation as in claim 4, said plurality of second layers comprises between about five and about ten second layers.

7. The simulation as in claim 1, wherein said third layer has a selectable stiffness modulus.

8. The simulation as in claim 7, wherein said selectable stiffness modulus is a stiffness modulus based on a fabric attribute selected from the group consisting of a number of fabric layers, a stitch pattern, a type of yarn, and a presence or absence of a stiffening member.

9. The simulation as in claim 1, wherein the simulation is solvable using linear FEA calculations.

10. The simulation as in claim 1, wherein the simulation is a zero-gravity simulation.

11. A garment-model computer simulation comprising:
a first layer being organized with a second layer;
a third layer being organized with said second layer;
a first region of the simulation having a first number of said second layers; and
a second region of the simulation having a second number of said second layers.

12. The simulation as in claim 11, further comprising an adjustable periphery, wherein adjustment of said adjustable periphery distorts a node spacing within each of said first, second, and third layers.

13. The simulation as in claim 11, further comprising a third region of the simulation having a third number of said second layers.

14. The simulation as in claim 11, wherein the simulation is solvable using linear FEA calculations.

15. The simulation as in claim 11, wherein the simulation is a zero-gravity simulation.

16. A garment-model computer simulation comprising:
a model portion having a first layer and at least one second layer, said at least one second layer being organized with said first layer; and
a garment portion having a third layer, said third layer being organized with said at least one second layer,
said at least one second layer comprising one second layer where said garment portion deforms said model portion in a single direction and said at least one second layer comprising a plurality of second layers where said garment portion deforms said model portion in a plurality of directions.

17. The simulation as in claim 16, wherein said garment portion has an adjustable periphery that, when adjusted, distorts a node spacing within each of said first, second, and third layers.

18. The simulation as in claim 17, wherein the simulation is solvable using linear FEA calculations.

19. The simulation as in claim 17, wherein the simulation is a zero-gravity simulation.

20. The simulation as in claim 17, wherein said model portion has a size that is selectable.
